(19) United States
(12) Patent Application Publication
(10) Pub. No.: US 2004/0012793 A1
(43) Pub. Date: Jan. 22, 2004

(54) Optical transmitter element and positioning device

(75) Inventor: Fredi Schubert, Schmalkalden (DE)

Correspondence Address: CHRISTINA HILDEBRAND, NORRIS, MCLAUGHLIN & MARCUS, 220 EAST 42ND STREET - 30TH FLOOR, NEW YORK, NY, 10017, US

(73) Assignee: PWB-Ruhlatec Industrieprodukte GmbH, Seebach (DE)

(21) Appl. No.: 10/263,526

(22) Filed: Oct. 3, 2002

(30) Foreign Application Priority Data
Jul. 19, 2002 (DE) 102 33 063.8

(51) Int. Cl. G01B 11/14

(52) U.S. Cl. 356/616

(57) ABSTRACT

In modifying the surface structure in the form of pit and land structures, together with a specific window design of the receiver or multiple receiver, specific information can be accommodated in the track to be scanned. It is also possible to arrange a plurality of tracks with different radii on one transmitter element, so that the number of signals to be processed and thus the quantity of information to be gathered can be increased considerably. This improves the application possibilities of the inventive transmitter element in many ways, and it is not only possible to obtain conventional position signals or measured signals, but it is also possible to define certain ranges within said types of signal by indexing same.

### BACKGROUND OF THE INVENTION

1. Field of the Invention

The invention relates to an optical transmitter element with incrementally distributed bar codes for determining the position and length, in particular of rotatingly or linearly moved machine parts, and to a positioning device.

2. Description of the Related Art

It is known that angle encoder wheels or encoder rulers (encoders) exist, wherein the codes consist of a series of lines or bars. Generally, high-transmission lines alternate with low-transmission or low-reflection lines, so that the signals containing the optical data changing in the process, which signals are emitted by an emitter, are modified in the transmitter element. In a signal processing stage, the modified signals are used to obtain information for position or length determining purposes.

It is also known to obtain material measurments by cutting windows or structuring metal layers, with absorbing layers alternating with high transmission window regions. Examples of such material measurments can be found in PWB-Ruhlatec patents in which suitable structures were obtained by exposing photographic films.

With such prior art structures, physical limits are set for resolution purposes and for the number of position signals obtained by the nature of the material and by the structuring technology used. For high-resolution structures with 180 or 360 lines per inch, standard deviations of the line widths of approximately 1 μm are usually achievable.

It is the object of the present invention to increase the accuracy and quantity of information which can be obtained from an optical transmitter element in such a way that an accuracy of 5000 lines per inch can be achieved with standard deviations of approximately 50 nm.

### SUMMARY OF THE INVENTION

In accordance with the invention, the objective is achieved by the characteristics of a new optical transmitter element and of a new positioning device. The optical transmitter element includes incrementally distributed bar codes. For determining the position or length, in particular of rotatingly or linearly moved machine parts, the bar codes include pit structures and land structures which comprises diffraction and interference structure. Further, a positioning and length measuring device including an emitter, an optical transmitter element with bar codes and a receiver which passes on the sent signals received in the transmission process to a signal evaluation or signal processing unit, wherein the bar codes comprise micro- and macro-structures in the form of pit and land structures and the signals received from the micro- and macro-structures through interference and diffraction in the pit and land regions are adjusted to the wave length of the signal sent.

In accordance with the invention, the material measure comprises a 3D micro-structure which is based on a light-diffracting 2D sub-micrometer grid structure. The phase of the transmitting or reflecting light wave is determined by the third dimension. As a result of the interference of several partial waves, the light waves whose phase position has been changed can be either intensified or weakened. The resulting signal can be used as a control signal in several ways in a signal processing device, for example, for position and path determining purposes:

1. Selecting the signals in the window of the 0th order and counting the digitalised pulses in the incremental sequence.

2. Selecting the signals in the window of the 1^{st} order and of further orders and decoding index signals which are generated by local changes in the pit structure (position and geometry of the structure of the pit).

The inventive micro-structure forms in the macro range above the μm structures an encoder pattern for the further control functions, for example by alternating window and bar structures. This is illustrated by way of example in FIG. 1 and will be explained in greater detail below.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1.1 illustrates an optical transitter of the present invention;

FIG. 1.2 illustrates a detail of FIG. 1 in the region of the bar code;

FIG. 1.3 illustrates a cross-section through a bar code structure of FIG. 2;

FIG. 2 illustrates a positioning device.

### DETAILED DESCRIPTION OF THE PRESENTLY PREFERRED EMBODIMENTS

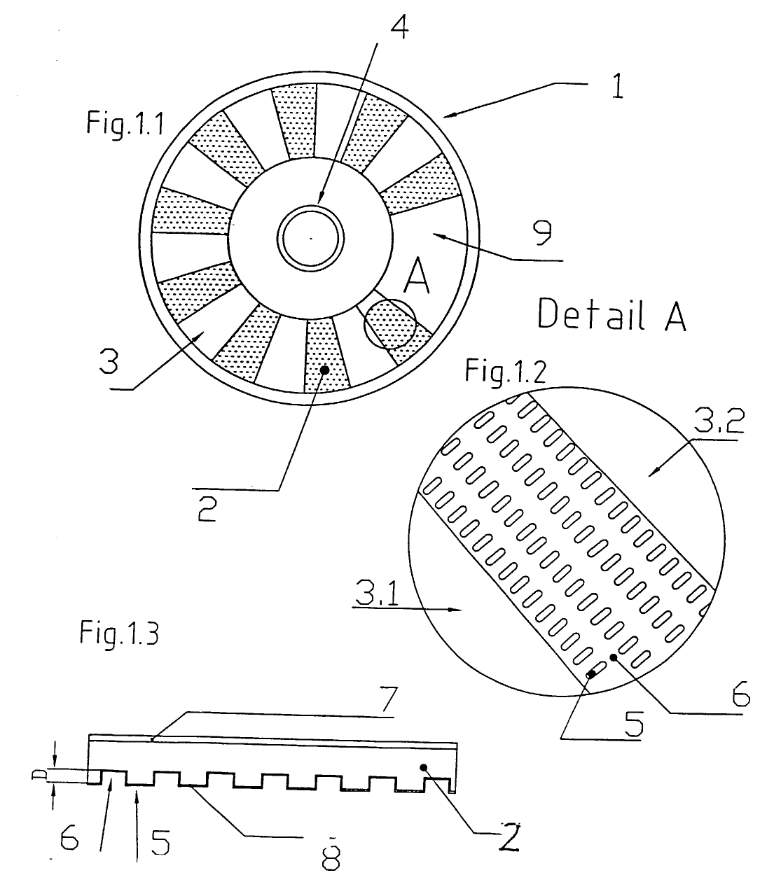

An optical transmitter element 1 comprises of a bar code 2 and transmission windows 3. In the example according to FIG. 1.1, the transmitter element is an encoder wheel which is provided with a hub 4 for being fixed to an encoder shaft (not shown). In this example, there is only one bar code track 9 on the encoder wheel which comprises a freely selectable optical radius which is limited by the LPI number (lines per inch).

FIG. 1.2 shows the detail A in the region of the bar code 2, consisting of pit structures (5) and land structures (6). These structures are delimited by lateral windows 3.1, 3.2 made of a transparent material. The alternating sequence of land and pit regions results in a diffraction and interference structure which can be used for position and length determining purposes.

FIG. 1.3 shows a cross-section through a bar code structure according to FIG. 1.2. The design is based on the pit structures (5) and land structures (6) and their thickness difference D which is calculated using the formula D=Lambda/2×(n−1). Furthermore, both sides of the optical transmitter element are provided with protective layers 7 and 8 for improving the wear strength which has to be taken into account in connection with the thickness difference. The material of the transmitter element comprises of polycarbonate having the refractive index n=1.55. The material of the protective layers preferably comprises of a plasma polymerizate or of a DLC coating.

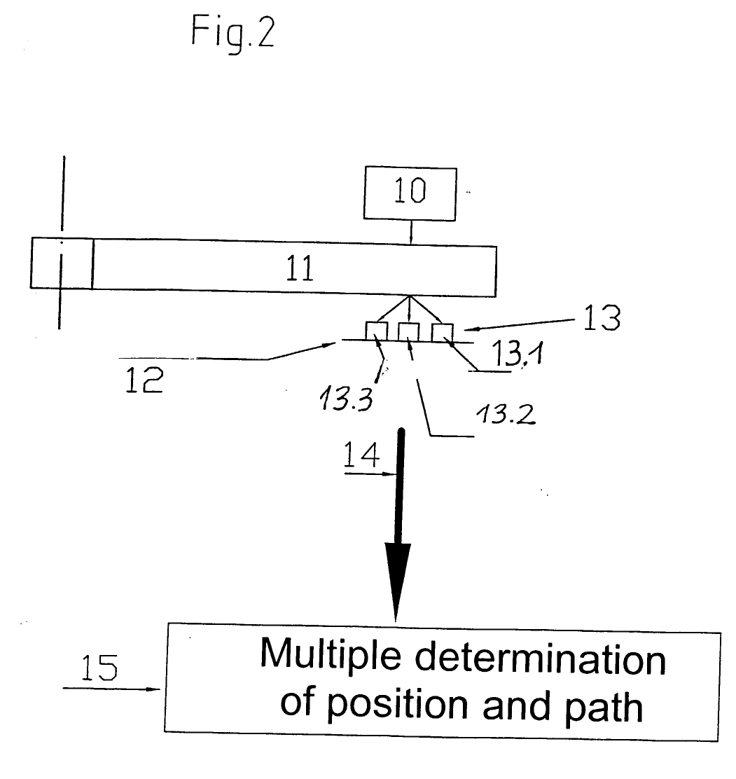

FIG. 2 shows a positioning device consisting of an emitter 10, for example an LED or laser diode, an optical transmitter element 11, for example a CD encoder wheel, and a receiver 12, for example a multiple receiver. The multiple receiver, in turn, comprises a plurality of window regions 13 for the diffraction signals of the 0^{th} and of the 1^{st} order. The arrow 14, in the sense of a flow diagram, indicates the transfer of the diffraction signals into a processing unit 15 to achieve multiple determination of position and path.

As compared to conventional positioning, the positioning device in accordance with the invention achieves an improvement in the resolution of the material measure, so that in future, even smaller disc diameters and even shorter measured lengths are sufficient for high-resolution encoder wheels and encoder rulers. Diffraction signals of a higher order are generated analogously with correspondingly larger window regions of a multiple receiver.

In accordance with the invention it was possible to achieve absolute structure accuracies which are better than 0.5 μm. This means that the accuracy of the material measure can be improved by the factor 20 as compared to the standard case.

A further advantage of the new transmitter element comprises in the possibility of carrying out function-integrating measures in said injection-moulded part, so that, for example, the hub function for receiving the engine shaft can be integrated into the optical transmitter element consisting of polycarbonate.

An additional advantage comprises in the high degree of planeness (low TIR, TIR=Total Induced Runout) of the new transmitter element, as a result of which the distances between the components of a positioning element can be reduced further. It is now possible to achieve distances between components of 0.5 mm and less, preferably 0.1 mm, with conventional components (LED, photo-transistors).

Wear resistance and security against fracture can be improved by the materials used to such an extent that the service life of the inventive device is increased by the factor 5 as compared to conventional devices.

As usual, the sensors required for selecting the signals are adjusted to the longitudinal density of the structures and thus to the LPI values (longitudinal density means “lines per transmitter element length”). For selecting the 0^{th} order it is possible to use conventional LED's, VCSEL or RLED if, through window optics, beam parallisation is possible.

In addition to the diffraction structures of the 0^{th} and 1^{st} order, as described, it is also possible to select diffraction signals of a higher order, if suitable light sources are available. However, this presupposes the use of light sources of a high degree of parallelism and coherence such as they can be achieved by means of certain solid state laser diodes.

In FIG. 2 it can be seen that there are provided several window openings (13.1 to 13.3) at the receiver end (12), with the windows 13.1 and 13.2 being provided for the diffraction signals of the 1^{st} order and the windows 13.3 for the diffraction signal of the 0^{th} order. The free intermediate regions can be used for diffraction signals of a higher order.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. An optical transmitter element (1) with incrementally distributed bar codes (2) for determining the position or length of rotatingly or linearly moved machine parts, wherein the bar codes (2) comprises pit structures and land structures which include a diffraction and interference structure.

2. The optical transmitter element according to claim 1, wherein the diffraction structure is represented by a 2D submicrometer grid structure.

3. The optical transmitter element according to claim 1, wherein the interference structure is provided in the form of the height difference between the pits and lands in a plane extending perpendicularly relative to the 2D sub-micrometer grid structure.

4. The optical transmitter element according to claim 1, wherein the regions between the bar codes (2) comprise a settable degree of transmission.

5. The optical transmitter element according to claim 1, wherein the regions between the bar codes (2) are transparent and the pit and land structures (5, 6) comprise a thickness difference D which complies with the following function:
D=λo/[2(n−1)],
with being the light wave length and n being the refractive index of the optical transmitter.

6. The optical transmitter element according to claim 1, wherein the material of the optical transmitter comprises of a polycarbonate with n=1.5.

7. The optical transmitter element according to claim 1, wherein the optical transmitter is an injection-moulded precision part into which there are formed additional functions for being positioned and fixed on a driveshaft.

8. The optical transmitter element according to claim 1, wherein a hub (4) is formed into the transmitter element (1).

9. The optical transmitter element according to claim 1, wherein the surface of the optical transmitter is provided with a wear protection layer (7, 8).

10. The optical transmitter element according to claim 1, wherein the wear protection layer (7, 8) is a plasma polymerizate or a DLC coating.

11. The positioning and length measuring device comprising an emitter (10), an optical transmitter element (1) with bar codes (2) and of a receiver (12) which passes on the sent signals received in the transmission process to a signal evaluation or signal processing unit (15), wherein the bar codes (2) include micro- and macro-structures in the form of pit and land structures (5, 6) and the signals received from the micro- and macro-structures through interference and diffraction in the pit and land regions are adjusted to the wave length of the signal sent.

12. The positioning device according to claim 1, wherein VCSEL or a RLED is used as the beam source of a laser diode.

13. The positioning device according to claim 1, wherein the diffraction structure used is a 2D sub-micrometer grid structure.

14. The positioning device according to claim 11, wherein the beam source or emitter (10) used is a LED (light emitting diode) with micro-optics.

15. The positioning device according to claim 1, wherein the transmitter element (1) used is an encoder wheel or an encoder ruler.

16. The positioning device according to claim 1, wherein the micro-structures of the optical transmitter are designed in such a way that the beams passing through in a non-deflected way (0^{th} diffraction order) are weakened to the maximum extent and that, through interference at the grid, the phases of the transmitted and reflected waves cause the total signal to be intensified or weakened.

17. A positioning device according to claim 1, wherein the emitter used is a beam source with a high degree of coherence and a small angular divergence of the beams and that, in addition, use is made of the higher diffraction orders of the optical signals of the micro-structures in connection with a plurality of receivers for selecting additionally introduced signals.

18. A positioning device according to claim 1, wherein there are generated additional diffraction signals for the absolute detection of one or several positions after a predetermined path or angular region of the transmitter element (1) has been covered.

19. The positioning device according to claim 13, wherein the beam source or emitter (10) used is a LED (light emitting diode) with micro-optics.
